(19) United States
(12) Patent Application Publication
(10) Pub. No.: US 2004/0179209 A1
(43) Pub. Date: Sep. 16, 2004

(54) Opical sensor device

(76) Inventor: Karl-Heinz Besch, Olching (DE)

Correspondence Address: HARNESS, DICKEY & PIERCE, P.L.C., P.O.BOX 8910, RESTON, VA, 20195, US

(21) Appl. No.: 10/480,431

(22) PCT Filed: Jun. 11, 2002
(86) PCT No.: PCT/DE02/02128

(30) Foreign Application Priority Data
Jun. 12, 2001 (DE) 101 28 476.4

(51) Int. Cl. G01B 11/14

(52) U.S. Cl. 356/614; 356/237.2

(57) ABSTRACT

The invention relates to an optical sensor device, especially for precise detection of the position of the printed circuit boards by means of markings placed on the printed circuit boards. Said optical sensor device comprises a light detector, an imaging lens system, a beam splitter and three different illuminating units which illuminate the substrate which is to be detected with the aid of different spectral colours and different illuminating angles. An automatic optimisation of the illuminating parameters for a plurality of different materials for the substrate and the markings arranged on said substrate is carried out by integrating various combinations of illuminating spectrums and illuminating angles in an individual sensor device by means of a control unit which controls the individual illuminating units.

The invention relates to an optical sensor device with which objects such as for example printed circuit boards or substrates can be detected by means of markings applied to the objects and the spatial positions of the objects can be determined precisely.

With the automatic assembly of printed circuit boards or ceramic substrates with components, in particular surface mounted device—SMD—components, in what are known as automatic pick and place machines, before assembly the position of the substrate to be equipped is determined by means of position detection devices. The term components is used below to include any objects that can be assembled, in particular electronic, electromechanical or even mechanical components, such as for example screening plates. Position is generally detected by means of vision systems, comprising a camera, for example a CCD camera, and an illuminating device. Vision systems are used for quality control as well as position detection. Defective substrates for example that are with intact substrates on a conveyor belt, are hereby identified and can then be removed from the automatated pick and place process.

Centering markings applied to substrates are used to detect the position of the substrates. Rejection markings applied to the substrates are used to identify defective substrates, so that these defective substrates can be identified during quality control and can then be removed from the pick and place process. Different materials such as ceramics, plastic, hard paper, plastic coated board and/or epoxy/glass fiber compounds are used for substrates that can be assembled. However plastic films are also used as substrates and being a flexible material they therefore allow bending or even folding. Substrate manufacturers also use different materials for the markings, such as for example glossy or matt metals or metal oxides and/or plastic or enamel coverings. Holes configured in the substrate are also frequently used as markings.

The manufacturers of assemblable substrates specify the substrates they manufacture generally only in relation to their electrical and not their optical characteristics. The optical characteristics of the different materials used for substrates and markings generally vary tremendously. This means that the contrast produced by illumination between the applied markings and the substrate background is also subject to large fluctuations. The illumination for the substrate should therefore be selected so that the markings applied to the substrate are shown up with the greatest possible contrast compared with the substrate background.

For this purpose an illuminating system is known from U.S. Pat. No. 5,469,294 that comprises one or a plurality of light sources, opaque partitions and mirrors. The illuminating system is used to illuminate markings on a substrate, in particular a semiconductor wafer, so that the markings can be detected by a camera that is oriented parallel to or at an angle to the substrate. The light sources comprise LEDs and broad spectrum emission lamps. Dark field illumination (illumination is essentially parallel to the optical axis of the camera) and bright field illumination (illumination is essentially perpendicular to the optical axis of the camera) are provided in order to achieve better identification of both light markings on a dark background and dark markings on a light background. A light control unit allows manual or automatic control of light intensity.

An illuminating device is known from WO 99/20093 that comprises a plurality of illuminating units, each of which emits light in a different spectral range from the others. The intensity of the illuminating units can be varied separately. This allows illumination with variable spectral distribution to be achieved, ensuring an adequate contrast when different materials are used both for the centering markings and for the printed circuit boards.

Illuminating devices known to date are characterized by a specific combination of illuminating spectrum and illuminating angle. The illumination used in each individual case is thereby selected specially from a plurality of possible illuminating spectra and illuminating angles for a specific substrate, whereby selection is essentially based on the material of the substrate and any material coating and the material and nature of the markings applied to the substrate. The operator is therefore forced to change and/or manually reorganize the illumination when the substrates to be assembled are changed, so that the illumination for the new combination of materials for the substrate and the markings applied to it allows the greatest possible contrast between substrate background and markings.

The object of the invention is therefore to create an optical sensor device that ensures appropriate illumination for a plurality of different combinations of substrate material and material for the markings applied to the substrate for reliable optical detection of the substrates, whereby when the substrate and/or marking material is changed, manual adjustment of the sensor device is not necessary.

This object is achieved according to the invention by means of an optical sensor device with a light detector, with an imaging lens system that maps a measuring field of an object to be detected onto the light detector, whereby the light detector is arranged on the optical axis of the imaging lens system, and with a beam splitter that is arranged on the optical axis between the light detector and the measuring field at an angle to the optical axis. The optical sensor device also comprises a first illuminating unit that illuminates the measuring field at an oblique angle, a second illuminating unit that illuminates the measuring field essentially parallel to the optical axis after reflection at the beam splitter and a third illuminating unit that illuminates the measuring field essentially approximately parallel to the optical axis, whereby at least one of the three illuminating units comprises at least two light elements emitting in different spectral ranges from each other.

According to two preferred embodiments of the invention at least two of the three illuminating units, in particular the second and the third illuminating units, comprise at least two light elements emitting in different spectral ranges from each other. The optical sensor device according to the invention therefore has the advantage that apart from the initial adjustments of the illuminating spectrum and illuminating angle that have to be carried out before operation of the optical sensor device, no further mechanical reorganization or other adjustment of the optical sensor device is necessary.

According to a further embodiment of the invention, the light detector is a CCD camera or a CMOS camera. This means that a commercially available CCD or CMOS chip can advantageously be used as the light detector, so the sensor device according to the invention can be produced at low cost.

According to further embodiments of the invention a diffuser is arranged between the first illuminating unit and the measuring field, between the second illuminating unit and the beam splitter and/or between the third illuminating unit and the measuring field. Use according to the invention of diffusers has the advantage that the light intensity of unwanted reflections is reduced and the contract detected by the light detector can therefore be increased.

According to a further preferred embodiment of the invention, the first illuminating unit comprises a light source emitting in the blue spectral range. The oblique illumination according to the invention of the measuring field with blue light has the advantage that in particular metallically reflecting marks on a light background, for example a ceramic substrate, can be detected by the light detector with a high level of contrast.

According to two further particularly preferred embodiments of the invention, the second illuminating unit and/or the third illuminating unit comprises a light source emitting white light and a light source emitting in the infrared spectral range. These embodiments have the advantage that tin-plated markings in particular can be reliably detected by means of white illumination with a steep angle of incidence. As tin-plated markings are used particularly frequently, white illumination that strikes the substrate to be measured at a steep angle preferably as diffused light, represents the most frequently used standard illumination for the optical sensor device. Infrared illumination that strikes the substrate to be measured at a steep angle, is particularly appropriate, if the markings applied to the corresponding substrate are coated for example with solder resist. Detection of coated markings is also improved, if the infrared light striking the substrate to be measured at a steep angle also strikes the substrate as diffused light.

According to another embodiment of the invention at least one of the light sources is an LED. Compared with other light sources LEDs have the advantage that they are on the one hand very economical and on the other hand they have a long life and low level of electrical energy consumption.

In a further embodiment of the invention the sensor device also comprises a control device, to which the light sources are connected and by means of which the individual light sources can be activated independently of each other. This has the advantage that both the intensity and also the pattern over time of the radiation emitted by the individual light sources can be determined individually and therefore optimum illumination can be achieved for different combinations of substrate material and material for the markings applied to the substrate.

According to a further development of the invention the control device has a parameter storage device for storing a plurality of parameters that determine different light source activation operations for different types of illumination. This means that the parameters for appropriate illumination can be stored for a plurality of different combinations of substrate material and materials used for the markings and in the event of a change in the material combination of substrate material and marking material, appropriate illumination can be set quickly and reliably for the new material combination.

To summarize, it can be determined that by integrating different combinations of illuminating spectra and illuminating angles in a single sensor device and with a control unit activating the individual illuminating units, the illumination parameters for a plurality of different materials for the substrate and the markings applied to the substrate can be optimized automatically.

Further advantages and features of the present invention will emerge from the following description of a typical currently preferred embodiment.

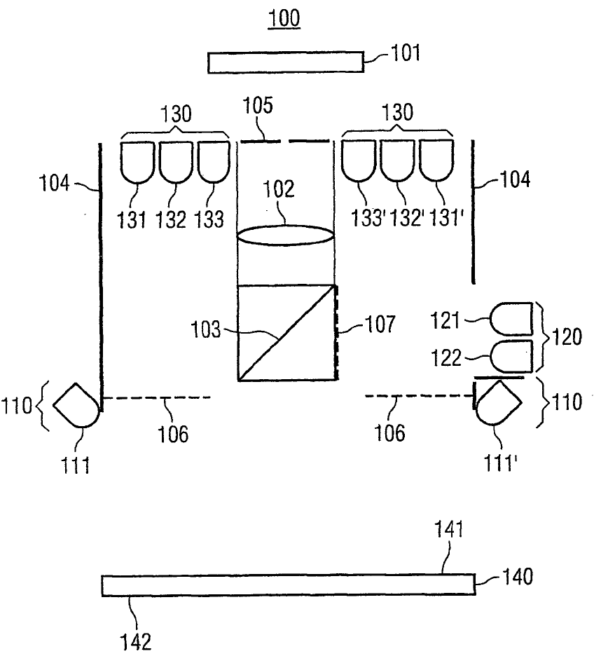

FIG. 1 shows an optical sensor device according to the invention as per a currently preferred embodiment of the invention.

FIG. 1 shows an optical sensor device 100 according to an embodiment of the invention. The sensor device 100 has a light detector 101, an imaging lens system 102, a beam splitter 103, a first illuminating unit 110, a second illuminating unit 120 and a third illuminating unit 130. The optical sensor device 100 is used according to the invention to detect a surface 141 of a printed circuit board 140. On the surface 141 of the printed circuit board 140 are markings (not shown) that are used to determine the position of the printed circuit board 140. The printed circuit board 140 generally lies with its printed circuit board lower side 142 on a conveyor belt (not shown). The printed circuit board 140, the beam splitter 103, the imaging lens system 102 and the light detector 101 are arranged on the optical axis (not shown) of the imaging lens system 102. A centering diaphragm 105 is also arranged between the light detector 101 that, according to the embodiment of the invention described here is a CCD chip or a CMOS camera, and the imaging lens system 102. The printed circuit board 140 to be measured is located on the object side of the imaging lens system 102. Accordingly the light detector 101 is located on the image side of the imaging lens system 102. The distances between the surface 141 of the printed circuit board 140 and the imaging lens system 102 and between the imaging lens system 102 and the light detector 101 are selected so that a measuring field (not shown), by means of which a partial area of the surface 141 of the printed circuit board 140 is detected, is mapped by the imaging lens system 102 onto the light detector 101.

The task of the three illuminating units 110, 120 and 130 is to illuminate the measuring field detected by the light detector 101 by means of the imaging lens system 102 in such a way that the structures on the surface 141 of the printed circuit board 140 that are located within the measuring field (not shown) can be detected by the light detector 101 with the greatest possible contrast. In order to achieve detection with the greatest possible contrast, the measuring field is illuminated using different illuminating angles.

The measuring field is illuminated at an oblique angle in relation to the optical axis of the imaging lens system 102 by means of the first illuminating unit 110 that comprises two LEDs 111, 111′. According to the embodiment of the invention described here, the two LEDs 111, 111′ emit light in the blue spectral range. Such oblique illumination using blue light means that in particular metallically reflecting markings on a light background, for example a ceramic substrate, can be reliably detected by the sensor device 100. The second illuminating unit 120 that comprises an LED 121 emitting white light and an LED 122 emitting infrared light, is used to illuminate the measuring field of the sensor device 100 approximately parallel to the optical axis of the imaging lens system 102. Said illumination of the measuring field approximately parallel to the optical axis of the imaging lens system 102 is achieved in that the light emitted by the two LEDs 121 and 122 is at least partially reflected at the beam splitter 103 and as a result the measuring field is illuminated approximately parallel to the optical axis of the imaging lens system 102. A diffuser 107 that is arranged between the two LEDs 121 and 122 and the beam splitter 103, ensures that the measuring field that is detected by the light detector 101 via the imaging lens system 102, is illuminated in a homogenous manner, i.e. with constant light intensity over the surface of the measuring field. The measuring field on the surface 141 of the printed circuit board 140 is also illuminated by the third illuminating unit 130 approximately parallel to the optical axis of the imaging lens system 102. As shown in FIG. 1, the third illuminating unit 130 comprises a total of six LEDs 131, 132, 133, 131′, 132′, 133′. According to the currently preferred embodiment of the invention described here the LEDs 131, 132, 131′, 132′ emit white light and the LEDs 133, 133′ emit infrared light. In order once again to achieve the most homogenous illumination possible of the measuring field, diffusers 106 are arranged between the LEDs 131, 132, 133 and the measuring field and between the LEDs 131′, 132′, 133′. A housing 104, shown schematically in FIG. 1, is used to attach the optical components used for the sensor device 100, i.e. to attach the light detector 101, the imaging lens system 102, the beam splitter 103, the centering diaphragm 105, the diffusers 106, 107 and to attach the three illuminating units 110, 120, 130. The infrared illumination of the measuring field by the second illuminating unit 120 and the third illuminating unit 130 is of particular significance when coated markings, for example markings covered with solder resist, are to be reliably detected with a high level of contrast.

In the case of covered markings, a better contrast factor is achieved with infrared illumination than with illumination with shorter wavelengths, because generally the material with which the markings are covered has a higher relative transmission for infrared light than for visible light. As a compromise between the transmission capacity of the marking covering material and the sensitivity of the CCD sensor used, according to the currently preferred embodiment of the invention light is used in a spectral range around the central wavelength of approx. 880 nm.

The second illuminating unit 120 and the third illuminating unit 130 are each set up so that the LEDs 121, 122, the LEDs 131, 132, 133 and the LEDs 131′, 132′, 133′ respectively are arranged on a plate. Despite this shared arrangement, all the LEDs 121, 122, 131, 132, 133, 131′, 132′, 133′ can be activated individually by a control device (not shown). This means that a further contrast improvement can be achieved by specific masking of the bright field section depending on the materials of the printed circuit board and the printed circuit board markings.

It should be pointed out at this point that the invention is by no means limited to the embodiment described with reference to FIG. 1. For example, in principle any number of LEDs can be used for each of the three illuminating units 110, 120 and 130, whereby the individual LEDs can emit light in any spectral ranges.

1. Optical sensor device, in particular for the precise detection of the position of printed circuit boards using markings applied to the printed circuit boards, with
A light detector
An imaging lens system that maps a measuring field of an object to be detected onto the light detector, whereby the light detector is arranged on the optical axis of the imaging lens system,
A beam splitter that is arranged on the optical axis between the light detector and the measuring field at an angle to the optical axis,
A first illuminating unit that illuminates the measuring field at an oblique angle,
A second illuminating unit that illuminates the measuring field essentially parallel to the optical axis after reflection at the beam splitter, and
A third illuminating unit that illuminates the measuring field essentially approximately parallel to the optical axis, whereby at least one of the three illuminating units comprises at least two light elements emitting in different spectral ranges from each other.

2. Sensor device according to claim 1, whereby at least two of the three illuminating units comprise at least two light elements emitting in different spectral ranges from each other.

3. Sensor device according to claim 1, whereby the second and third illuminating units comprise at least two light elements emitting in different spectral ranges from each other.

4. Sensor device according to one of claims 1 to 3, whereby the light detector is a CCD camera or a CMOS camera.

5. Sensor device according to one of claims 1 to 4, whereby a diffuser is arranged between the first illuminating unit and the measuring field.

6. Sensor device according to one of claims 1 to 5, whereby a diffuser is arranged between the second illuminating unit and the beam splitter.

7. Sensor device according to one of claims 1 to 6, whereby a diffuser is arranged between the third illuminating unit and the measuring field.

8. Sensor device according to one of claims 1 to 7, whereby the first illuminating device comprises a light source emitting in the blue spectral range.

9. Sensor device according to one of claims 1 to 8, whereby the second illuminating unit comprises a light source emitting white light and a light source emitting in the infrared spectral range.

10. Sensor device according to one of claims 1 to 9, whereby the third illuminating unit comprises a light source emitting white light and a light source emitting in the infrared spectral range.

11. Sensor device according to one of claims 1 to 10, whereby at least one of the light sources is an LED.

12. Sensor device according to one of claims 1 to 11, also comprising a control device, to which the light sources are connected and by means of which the light sources can be activated independently of each other.

13. Sensor device according to claim 12, whereby the control device comprises a parameter storage device for storing a plurality of parameters, said parameters determining different activation operations for the light sources for different types of illumination.
